(19) United States
(12) Patent Application Publication
(10) Pub. No.: US 2018/0162337 A1
(43) Pub. Date: Jun. 14, 2018

(54) ROLL AND BRAKE AUTOMATIC TEST SYSTEM AND METHOD

(71) Applicants: Hyundai Motor Company, Seoul (KR); Kia Motors Corporation, Seoul (KR)

(72) Inventors: Jihoon Park, Suwon (KR); Jun Yeon Park, Yongin (KR); Jin Seok Kim, Yongin (KR); David Oh, Gunpo (KR)

(21) Appl. No.: 15/650,576

(22) Filed: Jul. 14, 2017

(30) Foreign Application Priority Data
Dec. 14, 2016 (KR) 10-2016-0170792

(51) Int. Cl. B60T 17/22; F16D 65/18; B60T 17/08; F16D 66/02

(52) U.S. Cl. CPC B60T 17/22; F16D 65/18; F16D 2066/003; F16D 66/021; B60T 17/088

(57) ABSTRACT

A roll and brake automatic test system and method are provided. The system includes a preset roll and brake tester in which a vehicle is disposed at a preset position and which is set to test a travel state of the vehicle. A remote controller then tests travel performance and brake performance by operating the vehicle remotely.

### CROSS-REFERENCE TO RELATED APPLICATION

This application claims priority to and the benefit of Korean Patent Application No. 10-2016-0170792 filed in the Korean Intellectual Property Office on Dec. 14, 2016, the entire contents of which are incorporated herein by reference.

### BACKGROUND

### (a) Field of the Invention

The present invention relates to a roll and brake automatic test system and method, and more particularly, to a roll and brake automatic test system and method that test performance of a brake in a travel state by operating a vehicle wirelessly.

### (b) Description of the Related Art

A roll and brake test system ensures quality of a vehicle in an in-line process, and the test system may test a vehicle error, assembly properties, acceleration performance, and brake performance under a travel condition similar to a real situation that occurs when the vehicle is traveling on a road. The roll and brake test system uses a single machine and includes functions of an axle roll tester and a brake tester, and a vehicle power train and a brake system may be accurately evaluated using a single tester.

When a vehicle enters the roll and brake test system, an inspector enters the vehicle, sequentially performs acceleration, natural deceleration, neutral, braking, and stopping operations, and sets the vehicle to have a preset speed profile when the vehicle for when the vehicle is being driven. However, since the inspector manipulates a steering system, an accelerator pedal, a brake, and a gear shift lever of the vehicle, deviations in test quality occur in accordance with the inspector, time, and a driving condition. Therefore, research is being actively conducted regarding a method of deriving uniform test results in accordance with inspectors, time, and driving conditions.

The above information disclosed in this section is merely for enhancement of understanding of the background of the invention and therefore it may contain information that does not form the prior art that is already known in this country to a person of ordinary skill in the art.

### SUMMARY

The present invention provides a roll and brake automatic test system and method that improve productivity and stability by deriving uniform test results regardless of inspectors, time, and driving conditions.

An exemplary embodiment of the present invention provides a roll and brake automatic test system that may include a preset roll and brake tester in which a vehicle is disposed at a preset position and which is set to test a travel state of the vehicle; and a remote controller configured to test travel performance and brake performance by remotely operating the vehicle.

The vehicle may include: a transceiver configured to transmit and receive signals to and from the remote controller; and a vehicle controller configured to operate the vehicle using the signals transmitted and received by the transceiver. The vehicle may include a steering system, an accelerator, a transmission, and a brake device, and the vehicle controller may be set to operate the steering system, the accelerator, the transmission, and the brake device.

The brake device may include: an oil pump configured to pump brake oil by a motor; an ES valve configured disposed to supply the oil to an inlet side of the oil pump based on an opening degree thereof; an NO valve configured to supply the oil pumped by the oil pump to a brake pad based on an opening degree thereof; and a TC valve configured to reduce pressure of the oil pumped by the oil pump based on an opening degree thereof. The oil may be supplied to the inlet side of the oil pump by closing the TC valve and opening the ES valve, and braking force may be produced by opening the NO valve, and pumping the brake oil by operating the oil pump.

During a process of producing the braking force, the vehicle may be operated to be stopped by adjusting an opening degree of the TC valve, by duty-controlling the motor that provides rotational force to the oil pump, and adjusting the braking force in accordance with a preset profile. When the vehicle is stopped, the motor, which operates the oil pump, may be turned off, and the ES valve may be closed.

Another exemplary embodiment of the present invention provides a roll and brake automatic test method that may include: detecting a travel speed of a vehicle disposed at a roll and brake tester; determining whether a section is a braking section based on the detected travel speed; supplying brake oil to an inlet side of a pump for producing braking force by opening an ES valve in response to determining that the section is the braking section; and adjusting the braking force by supplying electric power to a motor for operating the pump by duty-controlling the electric power to be supplied to the motor.

The roll and brake automatic test method may further include opening an NO valve disposed at a discharge side of the pump to supply hydraulic pressure to a brake pad and adjusting the braking force by duty-controlling electric power to be applied to a TC valve configured to disperse hydraulic pressure formed at a discharge side of the pump to a master cylinder. In the supplying of the brake oil, oil accommodated in a master cylinder may be supplied to the inlet side of the pump by opening the ES valve.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a graph illustrating travel characteristics of a vehicle in a roll and brake test system according to the related art;

FIG. 2 is a graph illustrating travel characteristics that vary depending on inspectors in the roll and brake test system according to the related art;

FIG. 3 is a schematic configuration diagram of a roll and brake automatic test system according to an exemplary embodiment of the present invention;

FIG. 4 is a schematic configuration diagram of a brake system for a vehicle to which the roll and brake automatic test system according to the exemplary embodiment of the present invention is applied;

FIG. 5 is a schematic configuration diagram illustrating a state in which braking force is produced in the brake system for a vehicle according to the exemplary embodiment of the present invention.

FIG. 6 is a schematic configuration diagram illustrating a state in which braking force is adjusted in the brake system for a vehicle according to the exemplary embodiment of the present invention;

FIGS. 7 to 10 are schematic configuration diagrams illustrating a state in which a brake fluid is supplied, a state in which braking force is produced, a state in which the braking force is adjusted, and a state in which the vehicle is stopped, respectively, in the brake system for a vehicle according to the exemplary embodiment of the present invention; and

FIG. 11 is a flowchart illustrating a method of testing the brake device in the roll and brake automatic test system according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present invention will be described in detail with reference to the accompanying drawings.

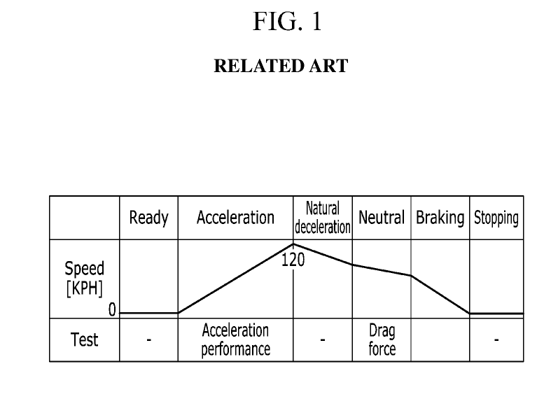

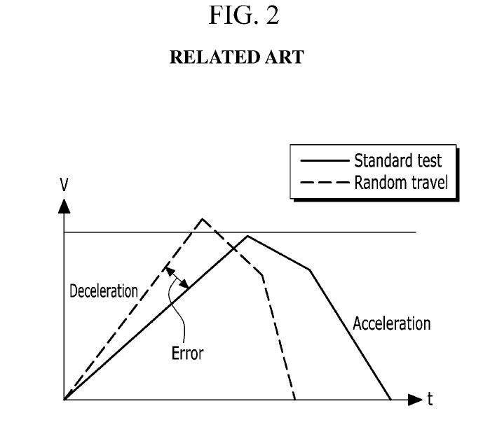

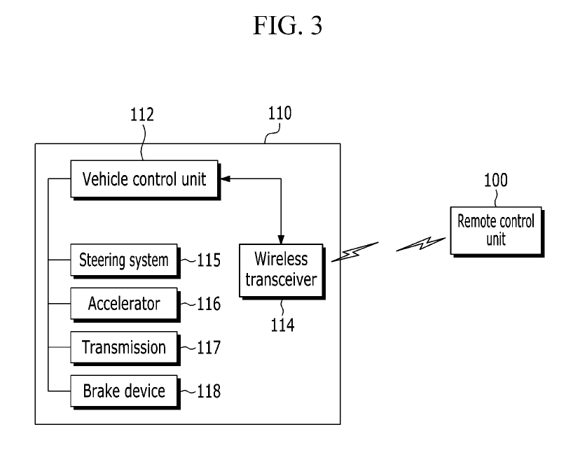

FIG. 1 is a graph illustrating travel characteristics of a vehicle in a roll and brake test system according to the related art, and FIG. 2 is a graph illustrating travel characteristics that vary depending on inspectors in the roll and brake test system according to the related art. Referring to FIG. 1, a vehicle sequentially performs ready, acceleration, natural deceleration, neutral, and braking operations for a preset period of time, and the roll and brake test system tests acceleration performance, drag force, and braking force for each region. However, as illustrated in FIG. 2, an error may occur between a standard test profile and a profile of an operator, and an automatic test system is introduced as a system for reducing the error. FIG. 3 is a schematic configuration diagram of a roll and brake automatic test system according to an exemplary embodiment of the present invention.

Referring to FIG. 3, the roll and brake automatic test system may include a vehicle 110 and a remote controller 100, and the vehicle 110 may include a wireless transceiver, a vehicle controller 112, a steering system 115, an accelerator 116, a transmission 117, and a brake device 118. The exemplary embodiment of the present invention facilities for a roll and brake automatic test and main constituent elements (e.g., the steering system, the accelerator, the transmission, and the brake device) of the vehicle are described referring to publicly known technologies, and detailed descriptions thereof will be omitted.

The remote controller 100 may be configured to apply a preset control signal to the wireless transceiver 114, and based on the control signal received at the wireless transceiver 114, the vehicle controller 112 may be configured to operate the steering system 115, the accelerator 116, the transmission 117, and the brake device 118 accordingly. Therefore, the travel of the vehicle may be remotely and accurately controlled when an inspector is not seated within the vehicle 110, and as a result, it may be possible to maintain test uniformity, more accurately test travel performance of the vehicle, increase test efficiency, reduce a work load of the inspector, and ensure stability in respect to an accident.

In particular, in the exemplary embodiment of the present invention, the remote controller 100 may be configured to operate the brake device 118 using the wireless transceiver 114 and the vehicle controller 112, thereby testing travel performance of the vehicle and brake performance. The remote controller 100 and the vehicle controller 112 may be implemented by one or more microprocessors operated by a preset program, and the preset program may include a series of commands for performing a method and a test according to the exemplary embodiment of the present invention which will be described below.

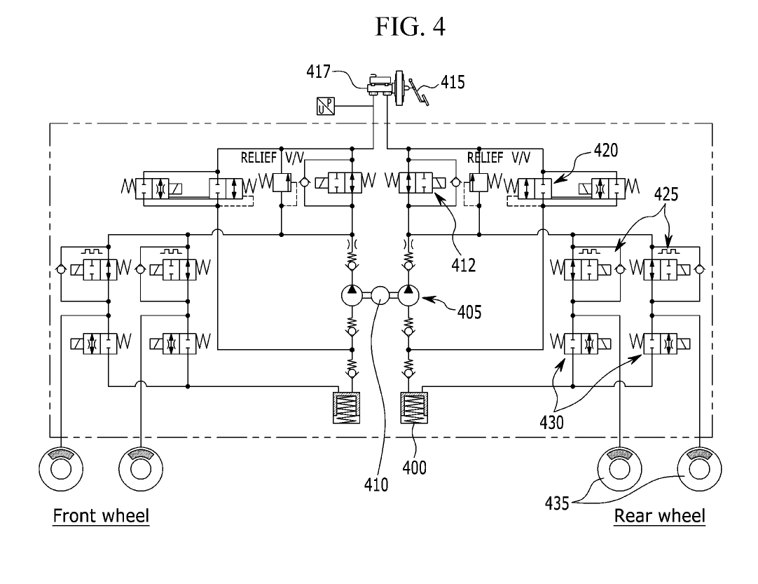

FIG. 4 is a schematic configuration diagram of a brake system for a vehicle to which the roll and brake automatic test system according to the exemplary embodiment of the present invention is applied. Referring to FIG. 4, the brake device 118 may include a brake pedal 415, a master cylinder 417, TC valves 412, ES valves 420, NO valves 425, NC valves 430, rear wheel discs 435, hydraulic pressure storage units 400, pumps 405, and a motor 410, as main constituent elements. Particularly, the vehicle includes a rear wheel and a front wheel, and in the present invention, the description is made with reference to the rear wheel. In addition, structures of the aforementioned main constituent elements of the brake device are described referring to already publicly known technologies, and detailed descriptions thereof will be omitted.

First, when the brake pedal 415 operates or a preset braking signal is generated, the ES valve 420 may be opened, and oil accommodated in the master cylinder 417 flows to an inlet side of the pump 405 via the ES valve 420. Further, the pump 405 may be operated by the motor 410, thereby pumping the oil. The NC valve 430 may be closed, the NO valve 425 may be opened, and the pumped oil may be delivered to a brake pad (not illustrated) of the rear wheel, thereby applying braking force to the rear wheel disc 435. In particular, when the NC valve 430 is opened or the TC valve 412 is opened, pressure of the pumped oil is attenuated, and the braking force may be reduced or adjusted.

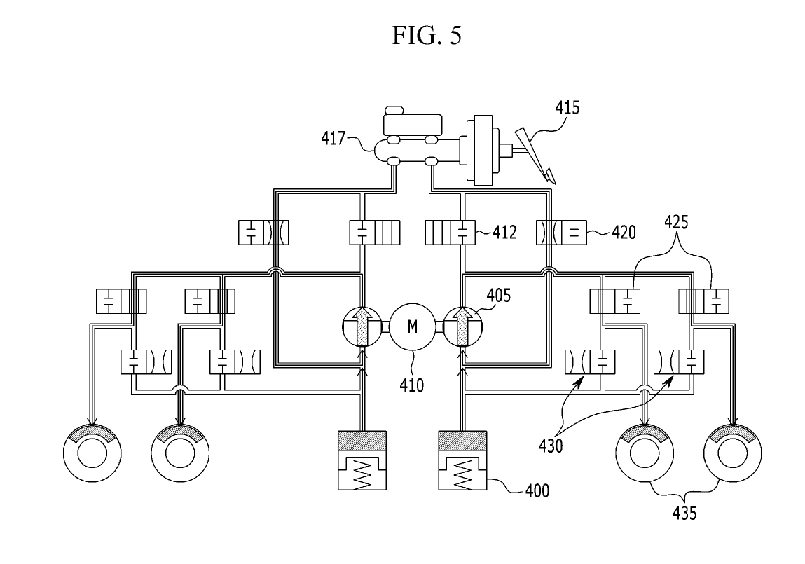

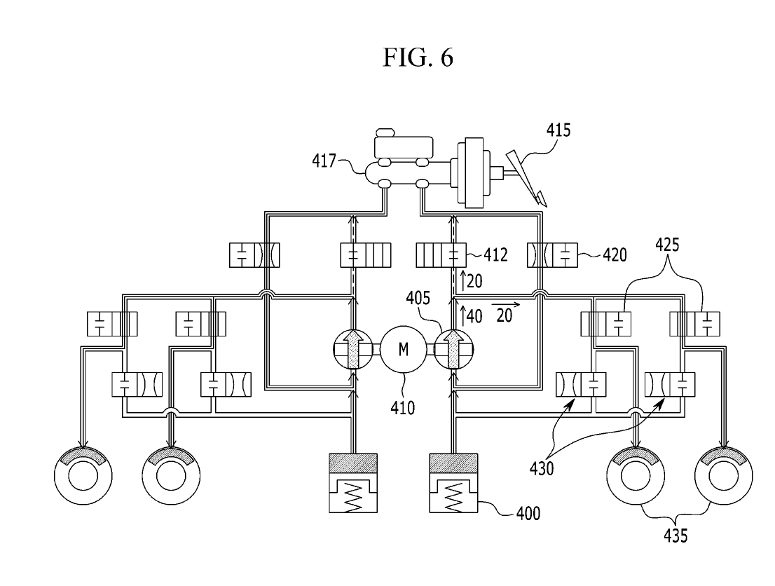

Moreover, FIG. 5 is a schematic configuration diagram illustrating a state in which braking force is produced in the brake system for a vehicle according to the exemplary embodiment of the present invention, and FIG. 6 is a schematic configuration diagram illustrating a state in which braking force is adjusted in the brake system for a vehicle according to the exemplary embodiment of the present invention. First, referring to FIG. 5, when the braking signal is generated, the ES valve 420 may be opened, the oil may be supplied to the inlet side of the pump 405, and the pump 405 may be operated by the motor 410.

Further, the NO valve 425 may be opened, and the NC valve 430 may be closed, to deliver hydraulic pressure formed by the pump 405 to the brake pad, thereby applying braking force to the rear wheel disc 435. Referring to FIG. 6, in the state illustrated in FIG. 5, an opening degree of the TC valve 412 may be adjusted to a set value by duty-controlling the TC valve 412, and the hydraulic pressure formed by the pump 405 may be adjusted to a set value by duty-controlling electric power to be applied to the motor 410. Therefore, it may be possible to more accurately adjust the braking force applied to the rear wheel disc 435. Similarly, it may be possible to more accurately adjust braking force applied to the front wheel disc.

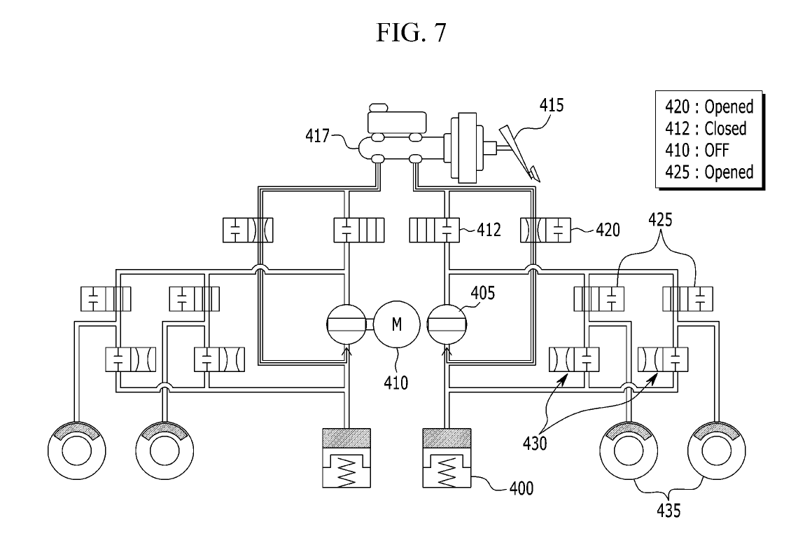

FIGS. 7 to 10 are schematic configuration diagrams illustrating a state in which a brake fluid is supplied, a state in which braking force is produced, a state in which the braking force is adjusted, and a state in which the vehicle is stopped, respectively, in the brake system for a vehicle according to the exemplary embodiment of the present invention. Referring to FIG. 7, when the preset braking signal is generated, the ES valve 420 may be opened, and the oil accommodated in the master cylinder 417 flows to the inlet side of the pump 405 via the ES valve 420. Particularly, the TC valve 412 may be closed, the motor 410 may be turned off, and the NO valve 425 may be opened.

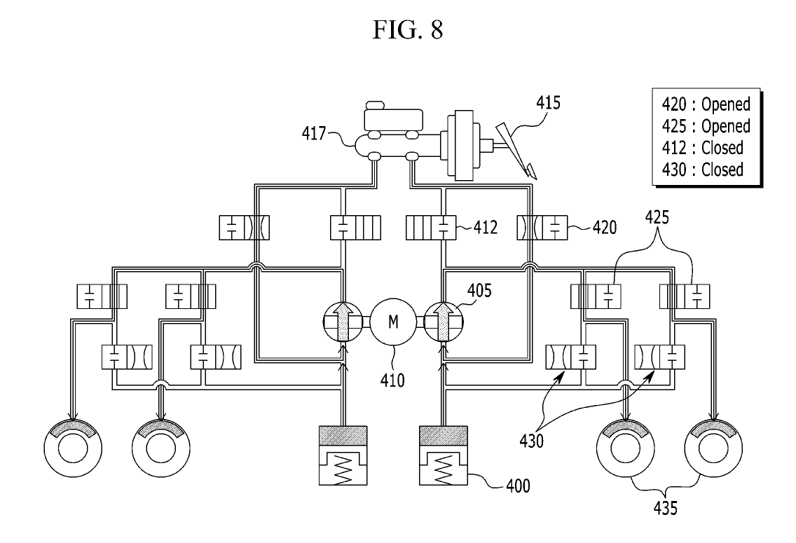

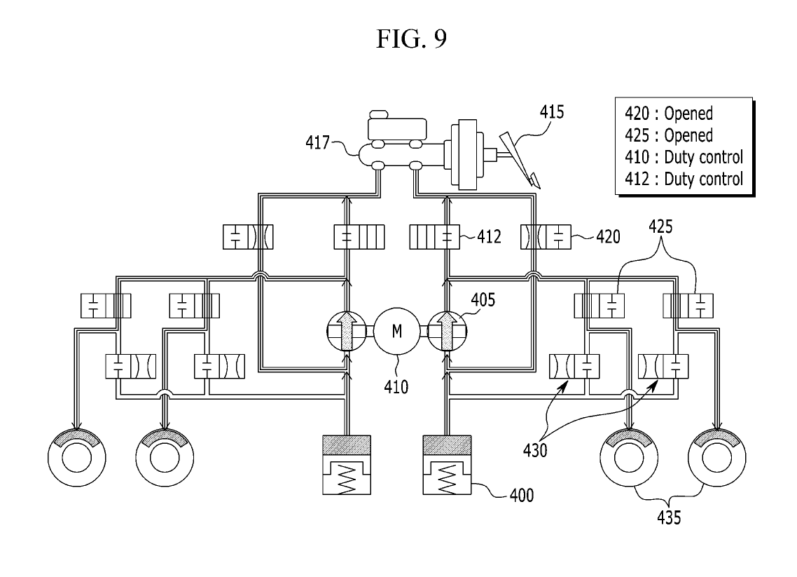

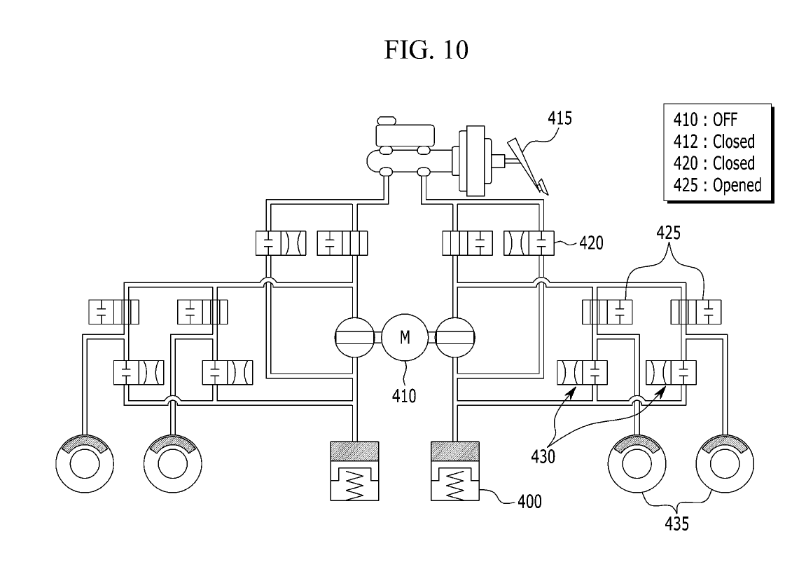

Referring to FIG. 8, in the state illustrated in FIG. 7, the pump 405 may be operated by the motor 410, the NO valve 425 may be opened, and the NC valve 430 may be closed. Therefore, the oil pumped by the pump 405 may be delivered to the rear wheel disc 435 through the NO valve 425, thereby producing the braking force. In particular, the TC valve 412 may be closed. Referring to FIG. 9, in the state illustrated in FIG. 8, the motor 410 may be duty-controlled, the TC valve 412 may be duty-controlled, and as a result, braking force applied to the rear wheel disc 435 may be adjusted to a preset profile. Referring to FIG. 10, in the state illustrated in FIG. 9, the motor 410 is turned off, the TC valve 412 may be opened, the NC valve 430 may be closed, the NO valve 425 may be opened, and the braking force may be eliminated.

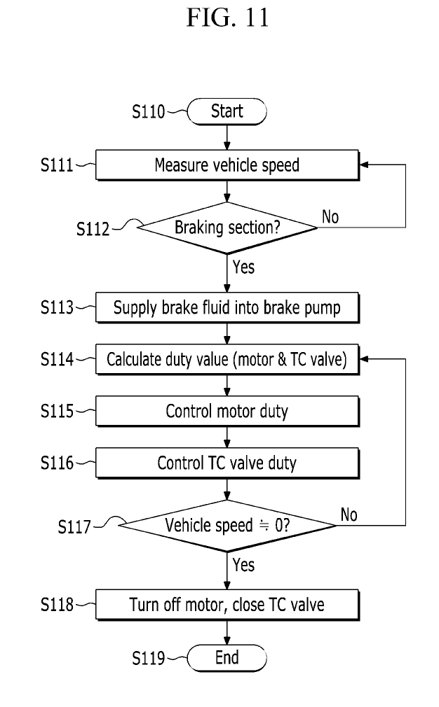

FIG. 11 is a flowchart illustrating a method of testing the brake device in the roll and brake automatic test system according to the exemplary embodiment of the present invention. The method described herein below may be executed by the above-described controllers. Referring to FIG. 11, a control operation starts in S110, and a travel speed of the vehicle may be measured in S111 using a sensor. In S112, whether the vehicle enters a braking section may be determined and in response to determining that the vehicle enters the braking section, S113 may be performed, otherwise, S111 may be performed. In S113, the oil of the master cylinder 417 may be supplied to the inlet side of the pump 405, as illustrated in FIG. 7. Further, in S114, a duty value applied to the motor 410 and the TC valve 412 may be calculated or selected.

As illustrated in FIG. 9, in S115, a duty value applied to the motor 410 may be adjusted to a set value, and in S116, a duty value applied to the TC valve 412 may be adjusted to a set value. In S117, whether a speed of the vehicle 110 (e.g., a speed of the rear wheel) is zero may be determined, and S114 may be performed when the speed of the vehicle 110 greater than zero, or S118 may be performed when the speed of the vehicle 110 is zero. In S118, the motor may be is turned off, electric power to be applied to the TC valve 412 may be turned off, and a flow path may be closed.

As described above, according to the exemplary embodiment of the present invention, the remote controller may be configured to operate the vehicle remotely under the same condition, and as a result, it may be possible to derive uniform test results regardless of inspectors, time, and driving conditions. Further, the motor of the oil pump for producing braking force may be duty-controlled, and an opening degree of the TC valve for attenuating pressure of the pumped oil may be adjusted, and as a result, it may be possible to more accurately adjust the braking force.

While this invention has been described in connection with what is presently considered to be exemplary embodiments, it is to be understood that the invention is not limited to the disclosed exemplary embodiments. On the contrary, it is intended to cover various modifications and equivalent arrangements included within the spirit and scope of the appended claims.

What is claimed is:

1. A roll and brake automatic test system, comprising:
a roll and brake tester in which a vehicle is disposed at a preset position and which is set to test a travel state of the vehicle; and
a remote controller configured to test travel performance and brake performance by operating the vehicle remotely.

2. The roll and brake automatic test system of claim 1, wherein the vehicle includes:
a transceiver configured to transmit and receive signals to and from the remote controller; and
a vehicle controller configured to operate the vehicle using the signals transmitted and received from the transceiver.

3. The roll and brake automatic test system of claim 2, wherein the vehicle includes a steering system, an accelerator, a transmission, and a brake device, and the vehicle controller is configured to operate each of the steering system, the accelerator, the transmission, and the brake device.

4. The roll and brake automatic test system of claim 3, wherein the brake device includes:
an oil pump which configured to pump brake oil by a motor;
an ES valve configured to supply the oil to an inlet side of the oil pump based on an opening degree thereof;
an NO valve configured to disposed to supply the oil pumped by the oil pump to a brake pad based on an opening degree thereof; and
a TC valve configured to reduce pressure of the oil pumped by the oil pump based on an opening degree thereof.

5. The roll and brake automatic test system of claim 4, wherein the oil is supplied to the inlet side of the oil pump by closing the TC valve and opening the ES valve, and braking force is produced by opening the NO valve, and pumping the brake oil by operating the oil pump.

6. The roll and brake automatic test system of claim 5, wherein while producing the braking force, the vehicle is stopped by adjusting an opening degree of the TC valve, by duty-controlling the motor that provides rotational force to the oil pump, and adjusting the braking force in accordance with a preset profile.

7. The roll and brake automatic test system of claim 6, wherein when the vehicle is stopped, the motor, which operates the oil pump, is turned off, and the ES valve is closed.

8. A roll and brake automatic test method, comprising:
detecting, by a controller, a travel speed of a vehicle disposed at a roll and brake tester;
determining, by the controller, whether a section is a braking section based on the detected travel speed;
supplying, by the controller, brake oil to an inlet side of a pump for producing braking force by opening an ES valve in response to determining that the section is the braking section; and
adjusting, by the controller, the braking force by supplying electric power to a motor for operating the pump by duty-controlling the electric power to be supplied to the motor.

9. The roll and brake automatic test method of claim 8, further comprising:
opening, by the controller, an NO valve disposed at a discharge side of the pump to supply hydraulic pressure to a brake pad.

10. The roll and brake automatic test method of claim 8, further comprising:
adjusting, by the controller, the braking force by duty-controlling electric power to be applied to a TC valve disposed to disperse hydraulic pressure formed at a discharge side of the pump to a master cylinder.

11. The roll and brake automatic test method of claim 8, wherein in the supplying of the brake oil, oil accommodated in a master cylinder is supplied to the inlet side of the pump by opening the ES valve.
